(19) United States
(12) Patent Application Publication
(10) Pub. No.: US 2017/0019642 A1
(43) Pub. Date: Jan. 19, 2017

(54) WEARABLE IMAGING DEVICE

(71) Applicant: ALTEK CORPORATION, Hsinchu City (TW)

(72) Inventors: Chao-Chang Mai, Taipei City (TW); Han-Wen Cheng, Taipei City (TW)

(21) Appl. No.: 14/854,017

(22) Filed: Sep. 14, 2015

(30) Foreign Application Priority Data
Jul. 17, 2015 (TW) 104211521

(51) Int. Cl. H04N 7/18; G06F 1/26; H04N 5/232

(52) U.S. Cl. CPC H04N 7/183; H04N 5/23212; G06F 1/266

(57) ABSTRACT

A wearable imaging device including a device body, an image lens, a linking strap, a first magnetic member and a second magnetic member is provided. The image lens is disposed on the device body. The linking strap has a first end and a second end, and the first end is connected to the device body. The first magnetic member is disposed at the second end of the linking strap. The second magnetic member is disposed on the device body. The first magnetic member is magnetically attached to the second magnetic member, so that the second end of the linking strap is detachably attached to the device body and thus, a hanging hole is formed.

### CROSS-REFERENCE TO RELATED APPLICATION

This application claims the priority benefit of Taiwan application serial no. 104211521, filed on Jul. 17, 2015. The entirety of the above-mentioned patent application is hereby incorporated by reference herein and made a part of this specification.

### BACKGROUND

Field of the Invention

The invention is directed to a wearable electronic device and more particularly, a wearable imaging device.

Description of Related Art

With the increasingly advancement in the technology industry, portable electronic devices, such as notebooks (NBs), tablet PCs and smart phones have been widely used in our daily life. Types, functions and usage of the electronic devices are increasingly diversified. In the meantime, the electronic devices have better portability due to being continuously developed toward miniaturization, so as to speed up the popularization of the electronic devices. In recent years, in order to enhance convenience of the portable electronic devices, a variety of wearable electronic devices, such as wearable imaging devices that can be directly worn on a user are therefore launched.

At present, when a wearable imaging device is held on clothes or a body, it often needs an additionally equipped holder or a holding fixture disposed on its device body. Therefore, the holder additionally equipped to or directly disposed on the wearable imaging device often lead to a large-volume appearance of the wearable imaging device as well as to an increase of overall weight of the device. Even worse, as for the wearable imaging device design, requirements for appearance aesthetics and miniaturization design of the entire wearable imaging device might be sacrificed for accommodating the holding fixture.

### SUMMARY

The invention provides a wearable imaging device, which can be conveniently hung on a user's clothes or body through configuration of a device body, magnetic members and a linking strap and through the magnetic members being detachably and magnetically attached to the device body surface.

According to an embodiment of the invention, a wearable imaging device including a device body, an imaging lens, a linking strap, a first magnetic member and a second magnetic member is provided. The imaging lens is disposed on the device body. The linking strap has a first end and a second end, and the first end is connected to the device body. In addition, the first magnetic member is disposed at the second end of the linking strap. The second magnetic member is disposed on the device body. The first magnetic member is magnetically attached to the second magnetic member, such that the second end of the linking strap is detachably attached to the device body, and a hanging hole is formed.

In an embodiment of the invention, the device body further includes a first status display element disposed by the imaging lens. The first status display element is adapted to send a first status signal, and the first status signal indicates an operation status of the imaging lens.

In an embodiment of the invention, the device body further includes a shutter button disposed on a side of the device body, and the shutter button is adapted to control the imaging lens to perform auto focus and capture an image.

In an embodiment of the invention, the device body further includes a power button disposed on the other side of the device body to turn on or turn off the power of the wearable imaging device.

In an embodiment of the invention, the device body further includes a second status display element disposed by the power button. The second status display element is adapted to send a second status signal, and the second status signal indicates a power status of the wearable imaging device.

In an embodiment of the invention, the linking strap is made of a flexible material.

In an embodiment of the invention, the device body further includes at least one slot serving as a universal serial bus (USB) slot, a memory module slot or a charging slot.

In an embodiment of the invention, a thin object is adapted to be held between the first magnetic member and the second magnetic member.

To sum up, in the wearable imaging device of the invention, with the disposition of the device body, the linking strap, the first and the second magnetic members, the wearable imaging device can be directly hung on a user's clothes or body, without additionally designing and disposing a holding fixture on the wearable imaging device. Therefore, the wearable imaging device of the invention does not have to sacrifice requirements for appearance aesthetics and miniaturization design for the disposition of the holding fixture. In the mean time, the invention substitute the simple magnetic members for the holding fixture in the related art, which can further facilitate in reducing parts of the device to lower down cost and complexity for the device assembly.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 is a schematic diagram illustrating a wearable imaging device according to an embodiment of the invention.

FIG. 2 is a schematic diagram illustrating a side of the wearable imaging device depicted in FIG. 1.

FIG. 3 is a schematic back-view diagram illustrating the wearable imaging device depicted in FIG. 1.

FIG. 4 is a schematic diagram illustrating the wearable imaging device depicted in FIG. 1 according to another embodiment.

FIG. 5 is a schematic diagram illustrating the other side of the wearable imaging device depicted in FIG. 1.

FIG. 6 is a schematic bottom-view diagram illustrating the wearable imaging device depicted in FIG. 1.

### DESCRIPTION OF EMBODIMENTS

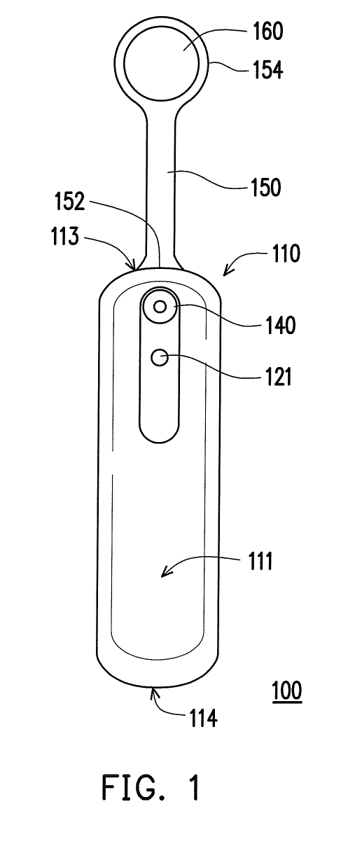

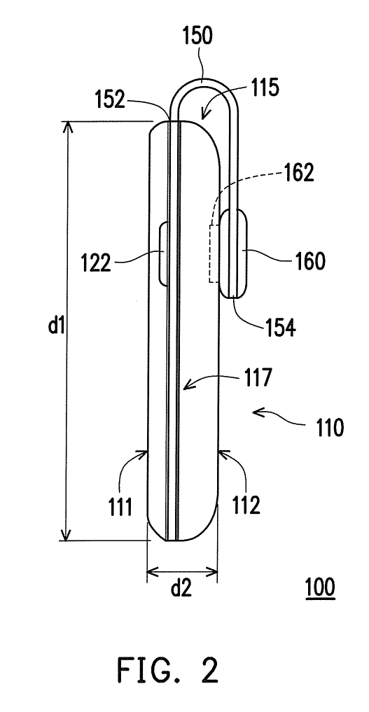

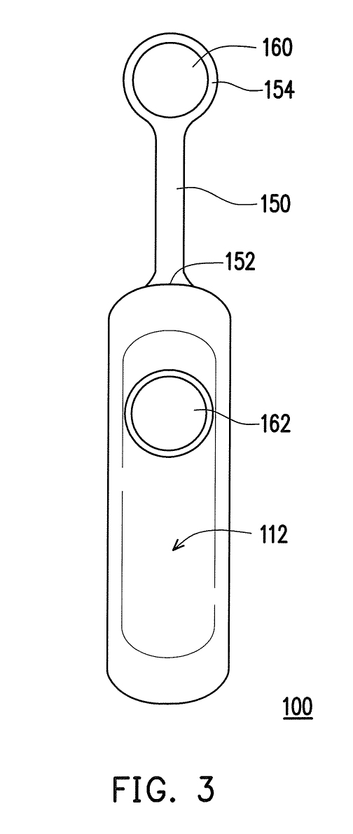

FIG. 1 is a schematic diagram illustrating a wearable imaging device according to an embodiment of the invention. FIG. 2 is a schematic diagram illustrating a side of the wearable imaging device depicted in FIG. 1. FIG. 3 is a schematic back-view diagram illustrating the wearable imaging device depicted in FIG. 1. Referring to FIG. 1 and FIG. 2, in the present embodiment, a wearable imaging device 100 includes a device body 110, an imaging lens 140, a linking strap 150, a first magnetic member 160 and a second magnetic member 162. Additionally, the device body 110 of the present embodiment may have a first surface 111 and a second surface 112 which are opposite to each other and a top 113. The top 113 is located between the first surface 111 and the second surface 112. Additionally, the imaging lens 140 is disposed on the first surface 111 of the device body 110. In the present embodiment, the imaging lens 140 has both a camera and a video photographing functions, and is an imaging lens with high resolution and a high speed, so as to obtain captured images with good quality. The linking strap 150 has a first end 152 and a second end 154. The first end 152 of the linking strap 150 is connected to the top 113 of the device body 110. Besides, the first magnetic member 160 may be disposed at the second end 154 of the linking strap 150, and the second magnetic member 162 may be disposed on the second surface 112 of the device body 110. In the present embodiment, the first magnetic member 160 may be magnetically attached to the second magnetic member 162, such that the second end 154 of the linking strap 150 is detachably attached to the second surface 112 of the device body 110, and thereby, a hanging hole 115 is formed.

In the present embodiment, the linking strap 150 may be made of leather, rubber, synthetic resins, elastic fabric or any other flexible material, such that the linking strap 150 is capable of being bent and stretched. Additionally, in the present embodiment, the first magnetic member 160 and the second magnetic member 162 are, for example, powerful magnets used to provide sufficient magnetic force between the second end 154 of the linking strap 150 and the second surface 112 of the device body 110. It should be mentioned that since effective and sufficient magnetic force may be provided between the first magnetic member 160 and the second magnetic member 162, a thin object (not shown) with a certain thickness may be held between the first magnetic member 160 and the second magnetic member, such that the wearable imaging device 100 may be directly hung on a pocket, a collar, a hat or a variety of accessories of user's clothing. In addition, the wearable imaging device 100 of the present embodiment may also be hung on a variety of portable leather good or handbags. Moreover, the first magnetic member 160 and the second magnetic member 162 may be magnetically fastened to each other to increase attractive stability between the second end 154 of the linking strap 150 and the second surface 112 of the device body 110. The wearable imaging device 100 of the present embodiment may substitute for the conventional holding member through the disposition of the linking strap 150, the first magnetic member 160 and the second magnetic member 162. Thus, device component parts can be further reduced in overall device design, so as to reduce assembly cost and complexity of the wearable imaging device 100.

Besides, referring to FIG. 1 and FIG. 2, the device body 110 of the present embodiment may have a first side 117, and the shutter button 122 of the imaging lens 140 may be disposed on the first side 117. In the present embodiment, the shutter button 122 is capable of controlling the imaging lens 140, and the shutter button 122 may control the imaging lens 140 to perform auto focus, video and camera functions. A first status display element 121 may be further disposed by the imaging lens 140 on the first surface 111 of the device body 110. The first status display element 121 may send a first status signal configured for indicating an operation status of the imaging lens 140.

Furthermore, the first status display element 121 of the present embodiment may be a light-emitting element (e.g., an LED), which is capable of indicating the first status signal in various types through a change of a light-emitting frequency or a light-emitting color, so as to indicate the operation status of the imaging lens 140. For instance, when the imaging lens 140 is used to take a photo or a video, the first status display element 121 may emit the first status signal of green light to indicate that the imaging lens 140 is in a capturing status. Additionally, when the imaging lens 140 is stopped from capturing, and the lens is closed, the first status display element 121 may emit red light to indicate that the imaging lens 140 is in a closed status. Moreover, the first status display element 121 may also be operated with the shutter button 122, and when the user lightly presses the shutter button 122 for performing auto focus, the first status display element 121 may emit a fast-flashing light to indicate that the imaging lens 40 is performing auto focus.

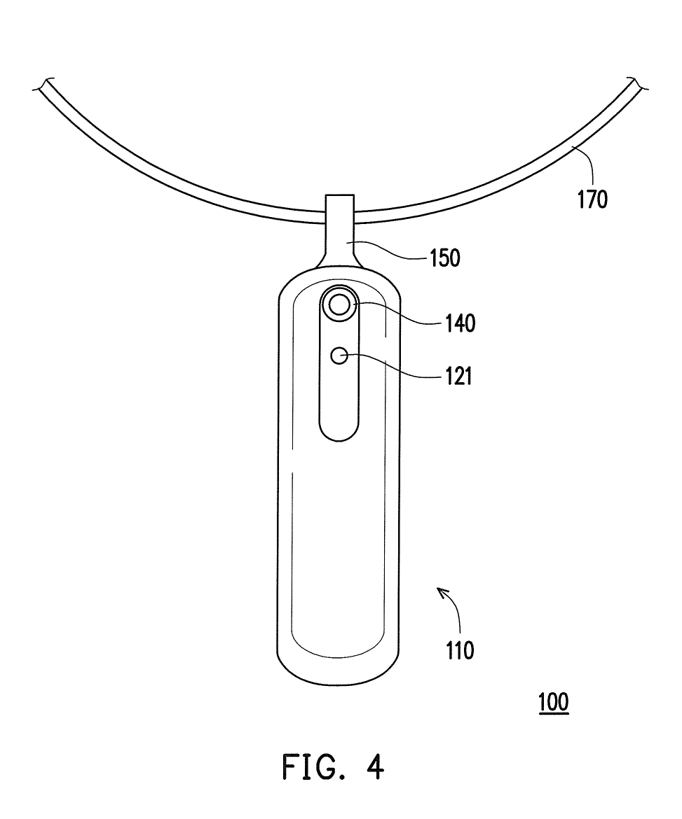

FIG. 4 is a schematic diagram illustrating the wearable imaging device depicted in FIG. 1 according to another embodiment. Referring both FIG. 2 and FIG. 4, as described above, when the first magnetic member 160 is magnetically attached to the second magnetic member 162, the second end 154 of the linking strap 150 is detachably attached to the device body 110, and a hanging hole 115 may be formed between the bent linking strap 150 and the second surface 112 of the device body 110. Additionally, the user may penetrate a flexible strap body 170, such as a chain or a hanging strap through the hanging hole 115 to hang the wearable imaging device 100 on the user's body or clothes. Furthermore, the appearance of the wearable imaging device 100 may be further designed as a styling accessory besides having the image capturing function. Thereby, the user may directly hang the wearable imaging device 100 on leather goods, handbags or portable items through the hanging hole 115 or further through the flexible strap body 170. Moreover, when in the end of the use of the wearable imaging device 100, the user may hang the wearable imaging device 100 on a wall hook by using the hanging hole 115 or the flexible strap body 170 for convenient accommodation. It should be noted that, referring to FIG. 2, a ratio of a length d1 to a thickness d2 of the device body 110 of the wearable imaging device 100 is about 8:1 in the present embodiment, and the length d1 may be only 70 to 90 mm. In other words, the wearable imaging device 100 of the present embodiment may have a thin device thickness, which can increase convenience in wearing, use and accommodation for the user.

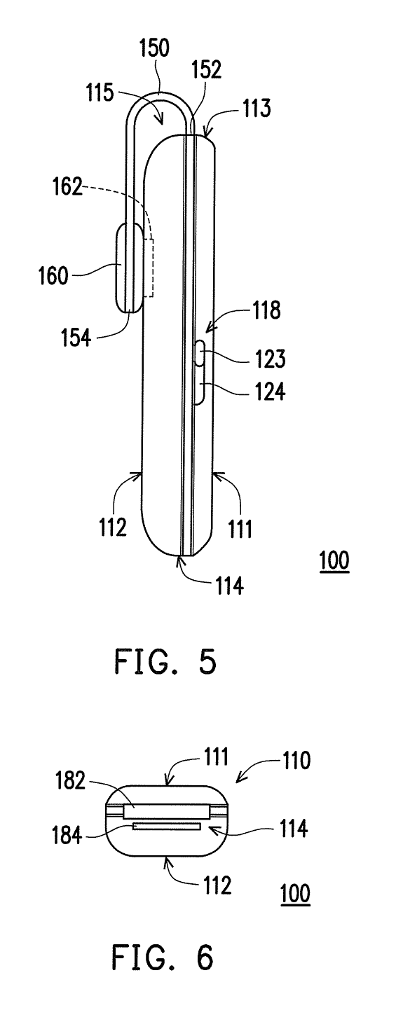

FIG. 5 is a schematic diagram illustrating the other side of the wearable imaging device depicted in FIG. 1. In the present embodiment, the device body 110 of the wearable imaging device 100 has a second side 118 opposite to the first side 117. In addition, the device body 110 may have a power button 124 disposed on the second side 118. The power button 124 may be configured for turning on or turning off the power of the wearable imaging device 100. Besides, the power button 124 of the present embodiment may be a physical button or a touch controlling button, and the invention is not intent to limit the form of the power button 124. Furthermore, the device body 110 may further have a second status display element 123 disposed by the power button 124. The second status display element 123 may send a second status signal, and the second status signal may be configured for indicating a power status of the wearable imaging device 100.

In detail, the second status display element 123 of the present embodiment may be a light-emitting element (e.g., an LED), which is capable of indicating the first status signal in various types through a change of a light-emitting frequency or a light-emitting color, so as to indicate the power status of the wearable imaging device 100. For instance, the second status display element 123 may be operated with the power button 124, and when the user lightly presses the power button 124 to turn on the power of the wearable imaging device 100, the second status display element 123 emits the second status signal of green light to indicate that the wearable imaging device 100 is in a power-on status. On the other hand, when the user light presses the power button 124 to turn off the power of the wearable imaging device 100, the second status display element 123 may emit red signal light to indicate that the wearable imaging device 100 is in a power-off status. Besides, when the power of the wearable imaging device 100 is exhausted, the second status display element 123 may also emit red signal light to indicate that the power of the wearable imaging device 100 is exhausted and remind the user for follow-up charging operation. In addition, before the power of the wearable imaging device 100 is exhausted, the second status display element 123 may emit continuously flashing light to remind the user that the power of the wearable imaging device 100 about to be exhausted.

FIG. 6 is a schematic bottom-view diagram illustrating the wearable imaging device depicted in FIG. 1. Referring to FIG. 6, in the present embodiment, the device body 110 has a bottom 114 opposite to the top 113, and the bottom 114 is located between the first surface 111 and the second surface 112. In the present embodiment, at least one slot may be disposed on the bottom 114 of the device body 110. For instance, referring to FIG. 6, a universal serial bus (USB) slot 182, a micro-USB slot or a charging slot used for data transmission with an external device or charging the wearable imaging device 100. In addition, a micro memory card slot 184 may also be disposed on the bottom 114 of the device body 110 to further expand the memory capacity of the wearable imaging device 100, such that the user may directly save the captured image files in the micro memory card (not shown).

In light of the foregoing, through the disposition of the device body, the linking strap, the first and the second magnetic members and through the magnetic force among the first and the second magnetic members and the device body in the wearable imaging device of the invention, the wearable imaging device can be directly hung on the user's clothes, without other additionally designed or provided holding fixtures. In addition, the user can penetrate the flexible strap body, such as a chain or a hanging strap through the hanging hole formed between the linking strap and the device body. Thereby, the user can directly hang the wearable imaging device on the body, clothes, or various portable items, such as leather goods, handbags or portable items, through the hanging hole formed between the linking strap and the device body or further through the flexible strap body. Therefore, the design of the wearable imaging device of the invention can facilitate in increasing the carrying and using convenience for the user. In the meantime, as for the appearance design, the wearable imaging device of the invention does not have to sacrifice appearance aesthetics and miniaturization design for the disposition of the holding fixture.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A wearable imaging device, comprising:
a device body, an imaging lens, disposed on the device body;
a linking strap, having a first end and a second end, wherein the first end is connected to the device body;
a first magnetic member, disposed at the second end of the linking strap; and
a second magnetic member, disposed on the device body, wherein the first magnetic member is magnetically attached to the second magnetic member, such that the second end of the linking strap is detachably attached to the device body to form a hanging hole.

2. The wearable imaging device according to claim 1, wherein the device body further comprises a first status display element disposed by the imaging lens, the first status display element is adapted to send a first status signal, and the first status signal indicates an operation status of the imaging lens.

3. The wearable imaging device according to claim 1, wherein the device body further comprises a shutter button disposed on a side of the device body, and the shutter button is adapted to control the imaging lens to perform auto focus and capture an image.

4. The wearable imaging device according to claim 3, wherein the device body further comprises a power button disposed on the other side of the device body to turn on or turn off the power of the wearable imaging device.

5. The wearable imaging device according to claim 4, wherein the device body further comprises a second status display element disposed by the power button, the second status display element is adapted to send a second status signal, and the second status signal indicates a power status of the wearable imaging device.

6. The wearable imaging device according to claim 1, wherein the linking strap is made of a flexible material.

7. The wearable imaging device according to claim 1, wherein the device body further comprises at least one slot serving as a universal serial bus (USB) slot, a memory module slot or a charging slot.

8. The wearable imaging device according to claim 1, wherein a thin object is adapted to be held between the first magnetic member and the second magnetic member.
